(19) United States
(12) Patent Application Publication
(10) Pub. No.: US 2005/0152655 A1
(43) Pub. Date: Jul. 14, 2005

(54) Optical fiber and manufacturing method thereof and image forming apparatus

(75) Inventor: Hiroshi Sunagawa, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/024,827

(22) Filed: Dec. 30, 2004

(30) Foreign Application Priority Data
Jan. 9, 2004 (JP) 2004-4096

(51) Int. Cl. G02B 6/20

(52) U.S. Cl. 385/125

(57) ABSTRACT

The present invention provides an optical fiber having a rectangular core in which propagation loss of a light beam is small and manufacturing can be performed at low cost, a method of manufacturing the optical fiber, and an image forming apparatus including the optical fiber. The optical fiber having the core, whose sectional shape in a direction orthogonal to an optical axis direction of a light beam becomes rectangular, is formed by: filling a cylindrical tube with multiple hollow capillaries; extracting hollow capillaries located in a rectangular area having a predetermined size in a portion which is substantially central to the tube; inserting rods having the same diameter as the extracted hollow capillaries to replace the hollow capillaries to produce a preform; performing wire drawing while the preform is melt-fused; and covering the preform with a cover layer.

### CROSS-REFERENCE TO RELATED APPLICATION

This application claims priority under 35 USC 119 from Japanese Patent Application No. 2004-4096, the disclosure of which is incorporated by reference herein.

### BACKGROUND OF THE INVENTION

1. Field of the Invention

The present invention relates to: an optical fiber, which guides a light beam; a method of manufacturing the optical fiber; and an image forming apparatus, which forms an image by irradiating a recording medium with the light beam guided by the optical fiber.

2. Description of the Related Art

An image forming apparatus is know in which: an optical fiber is connected to a light source, such as a semiconductor laser; a light beam output from the optical fiber is focused with a focusing lens (focusing optical system); and a recording medium, arranged at the focusing position of the light beam, is irradiated to form (record) an image on a recording medium.

An optical fiber having a core/cladding configuration is usually used in an image forming apparatus. The core/cladding configuration includes a core and a cladding, the core having a circular sectional shape, in a direction orthogonal to an optical axis direction of the light beam, and the core is coated with the cladding. A profile of the output light of the optical fiber has a circular shape, and a shape of the light beam spot scanned on a recording medium also has a circular shape. However, it is considered that a rectangular shape is more desirable than a circular shape for the shape of the light beam spot. This is because light intensity is substantially constant in a width direction (sub-scanning direction), variations in line width and dot density (coverage) caused by increases or decreases in light quantity are small, and a good image can be reliably obtained.

A rectangular beam spot can be obtained by using as the light source a semiconductor laser whose output light profile is rectangular in shape, e.g., a broad area type semiconductor laser. However, since a broad area type semiconductor laser has a high output, the amount of heat generated is large and, particularly when arrayed, there is a problem that cooling becomes difficult. Further, when a broad area type semiconductor laser is incorporated as a light beam output source into an exposure head of an image forming apparatus, there is the problem that replacement of a new semiconductor laser becomes troublesome when a semiconductor laser stops functioning correctly.

In order to obtain a rectangular beam spot without using a broad area type semiconductor laser, an optical fiber in which the core is formed rectangular in shape has been proposed (for example, see Japanese Patent Application Laid-Open (JP-A) No. 2000-310746). A beam spot, based on a laser beam output from such an optical fiber, is formed in a rectangular shape on the recording medium. This means that the above-described effect can be obtained, in which the line width is not changed even if the light quantity is varied, and the like. Further, if the recording medium is a heat mode type photosensitive material, when the beam size (width) in a main scanning direction is made smaller than that in the sub-scanning direction, sensitivity can be greatly improved.

A heat mode type photosensitive material is one in which recording is performed by causing a physical change or a chemical change by photo-thermal conversion after the exposure. When exposure speed becomes slow, a heat mode type photosensitive material has low-intensity reciprocity law failure characteristics in which a greater exposure energy is required due to the heat generated being dissipated (characteristics where by the photosensitivity decreases as the intensity decreases and the exposure time increases). Therefore, when an image is formed (recorded) using a heat mode type photosensitive material, from the viewpoint of decreasing exposure energy using high intensity and short-time exposure, it is desirable that the beam size in the main scanning direction is smaller than that in the sub-scanning direction.

However, in order to manufacture an optical fiber whose core shape is rectangular, as shown in FIG. 8B, a base material (hereinafter referred to as preform) 60 is made including: a core 62, whose sectional shape is rectangular; and a cladding 64, which covers the core 62. Wire drawing is carried out on the preform 60 while the preform 60 is heated and melted by a heating apparatus 68, as shown in FIG. 8A, and the cladding 64 is covered with a cover layer 66. During wire drawing of the preform 60, it is difficult to maintain the shape of the core 62 in the desired rectangular shape. That is, reproducibility of the rectangular core 62 is not good.

Further, it is difficult to integrally form the preform 60, including the core 62 whose sectional shape is rectangular, and the cladding 64 which covers the core 62. In reality the cladding 64 is separated into plural parts to cover the rectangular core 62. Therefore, air can contaminate the joint surfaces of the parts of the cladding 64 and, in a finished optical fiber 70, there is the problem that scattering is generated because of air bubbles formed at the interface between the core 62 and the cladding 64. That is, since the interface between the core 62 and the cladding 64 has poor smoothness, there is a problem that propagation loss in the light beam is large and the utilization efficiency of the light beam is decreased greatly.

Therefore, in the optical fiber 70, a process of optically polishing the interface between the core 62 and the cladding 64 is required, in order to solve the above-described problems, and this results in the optical fiber 70 being remarkably expensive. Thus, an optical fiber with a light beam whose spot shape is rectangular can be obtained, but the optical fiber cannot yet be favorably utilized.

### SUMMARY OF THE INVENTION

The present invention has been made in view of the above circumstances and provides an optical fiber having a rectangular core, in which propagation loss in the light beam is small, and manufacturing can be performed at low cost. It also provides methods of manufacturing the optical fiber, and an image forming apparatus including the optical fiber.

An optical fiber of a first aspect of the invention includes: a core, whose sectional shape in a direction orthogonal to an optical axis direction of a light beam is a rectangle; and a cladding, with which the core is covered, wherein the cladding is structured by multiple hollow capillaries integrated with the core by melt-fusing.

In the optical fiber of the first aspect, since the cladding is formed by multiple hollow capillaries integrated with the core by melt-fusing, the problem of bubbles existing in the interface between the cladding and the core does not occur. Therefore, there is no possibility that scattering is generated. As a result, a process of optically polishing the interface between the cladding and the core is not required, so the optical fiber can be manufactured at low cost.

In the cladding integrated with the core, multiple holes aligned in the optical axis direction of the light beam are formed to have a periodic structure and decrease an effective refractive index, so that the light beam can be guided while trapped in the core. Therefore, propagation loss of the light beam (quantity of the light loss) is decreased, and a decrease in utilization efficiency of the light beam is prevented.

An optical fiber manufacturing method of a second aspect of the invention includes: forming a base material of a core whose section is rectangular; inserting the base material of the core into a cylindrical tube and arranging coaxially the base material of the core and the tube; producing a preform by filling the tube into which the base material of the core has been inserted with multiple hollow capillaries; performing wire drawing while the preform is melt-fused; and covering the preform with a cover layer to produce an optical fiber having a rectangular core.

According to the second aspect, the optical fiber is produced by arranging coaxially the base material of the core whose section is rectangular and a cylindrical tube by inserting core into the tube, forming a preform by filling the tube with multiple hollow capillaries, and performing wire drawing while the preform is melt-fused. Therefore, the melt-fused multiple hollow capillaries become the cladding, with which the core is integrally covered, and the rectangular shape of the core is maintained (the second aspect provides excellent reproducibility of the rectangular core).

Since the problem of bubbles existing at the interface between the cladding and the core does not occur, there is no possibility that scattering is generated. As a result, a process of optically polishing the interface between the cladding and the core is not required, so the optical fiber can be manufactured at low cost. In the cladding integrated with the core, multiple holes aligned in the optical axis direction of the light beam are formed to have a periodic structure (at even spacings) and substantially decrease the effective refractive index, so that the light beam can be guided while trapped in the core. Therefore, the propagation loss of the light beam (quantity of light loss) is decreased, and a decrease in utilization efficiency of the light beam does not occur.

An optical fiber manufacturing method of a third aspect of the invention includes: filling a cylindrical tube with multiple hollow capillaries; extracting hollow capillaries, from the multiple hollow capillaries with which the tube is filled, in a rectangular area having a predetermined size in a portion substantial central to the multiple hollow capillaries, and inserting rods having the same diameter as the extracted hollow capillaries, replacing the extracted hollow capillaries to produce a preform; performing wire drawing while the preform is melt-fused; and covering the preform with a cover layer to produce an optical fiber having a rectangular core.

According to the third aspect, the optical fiber is produced by filling a cylindrical tube with multiple hollow capillaries, extracting hollow capillaries, from the multiple hollow capillaries with which the tube is filled, in a rectangular area having a predetermined size in a portion substantial central to the multiple hollow capillaries, and inserting rods having the same diameter as the extracted hollow capillary, replacing the extracted hollow capillaries to produce a preform, and performing wire drawing while the preform is melt-fused. Therefore, the rectangular core is formed by the multiple melt-fused rods, and the multiple melt-fused hollow capillaries become the cladding with which the core is integrally covered, so that the third aspect provides excellent reproducibility of the rectangular core.

Since the problem of bubbles existing in the interface between the cladding and the core does not occur, there is no possibility that scattering is generated. As a result, a process of optically polishing the interface between the cladding and the core is not required, so the optical fiber can be manufactured at low cost. In the cladding integrated with the core, the multiple holes aligned in the optical axis direction of the light beam are formed to have a periodic structure (substantially evenly spaced) and decrease the effective refractive index, so that the light beam can be guided while trapped in the core. Therefore, the propagation loss of the light beam (quantity of light loss) is decreased, and a decrease in utilization efficiency of the light beam is does not occur.

An image forming apparatus of a fourth aspect of the invention includes: a light source which emits a light beam; an optical fiber of the first aspect which is optically connected to the light source; and an optical focusing system which focuses the light beam output from the optical fiber onto a recording medium.

According to the fourth aspect, the recording medium is exposed by focusing the light beam output from the optical fiber of the first aspect with the optical focusing system. Since a profile of the light beam output from the optical fiber has a rectangular shape, a shape of the light beam spot focused on the recording medium also becomes rectangular. Therefore, variations in line width and dot density (coverage) caused by increases or decreases in light quantity are small, and good images can be obtained reliably.

As described in the above, according to the invention are provided: an optical fiber having a rectangular core in which the propagation loss of the light beam is small and which can be manufacturing at low cost; methods of manufacturing the optical fiber; and an image forming apparatus including the optical fiber.

### BRIEF DESCRIPTION OF THE DRAWINGS

FIG. 1 is a schematic perspective view of an image forming apparatus.

FIG. 2 is a schematic perspective view showing a configuration of an optical unit in the image forming apparatus.

FIG. 3 is a schematic cross section showing a configuration of an optical fiber.

FIG. 4 is a schematic cross section showing a configuration of an optical fiber.

FIG. 5 is a schematic cross section showing a configuration of an optical fiber.

FIG. 6 is a schematic cross section showing a configuration of an optical fiber.

FIG. 7 is an explanatory view showing laser beam intensity of the optical fiber.

FIG. 8A is an explanatory view showing a process of manufacturing the optical fiber, and FIG. 8B is a schematic cross section of a conventional optical fiber.

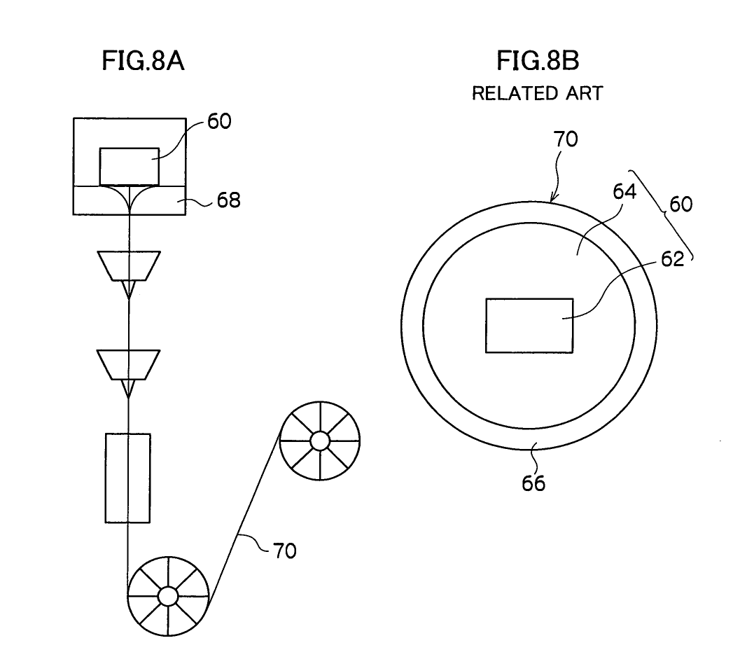

### DETAILED DESCRIPTION OF THE INVENTION

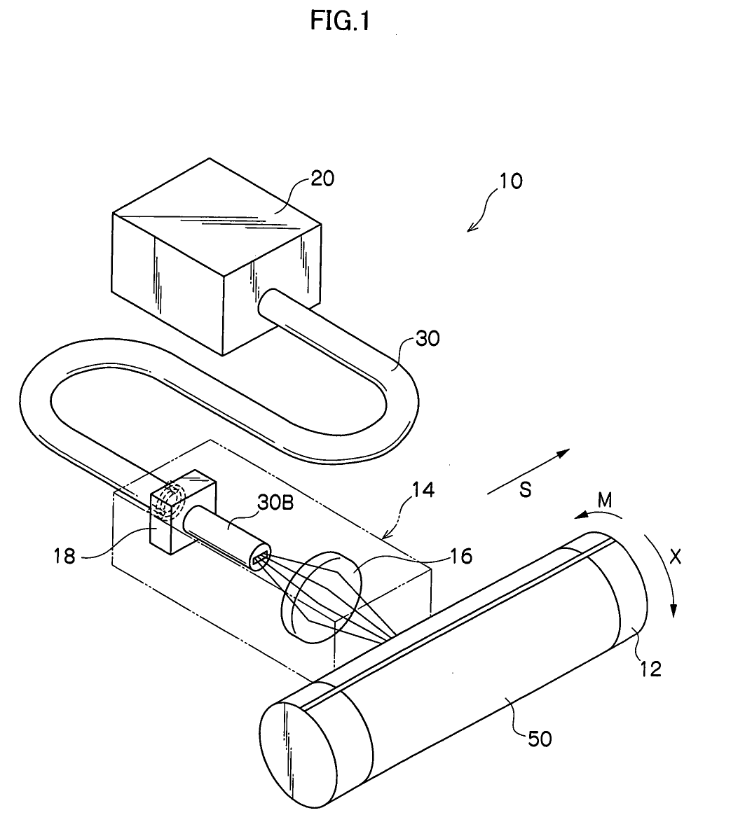

Referring to the accompanying drawings, an embodiment of the present invention will be described in detail below. FIG. 1 shows an example of an image forming apparatus 10 according to the invention. A heat mode type photosensitive material 50 which is of the recording medium is mounted on (absorbed onto) an outer peripheral surface of a cylindrical drum 12 which rotates at a constant speed. The heat mode type photosensitive material 50 is a photosensitive material using an evaporation film ablation method. Since the image is directly written on the heat mode type photosensitive material 50 by a laser or the like, heat mode type photosensitive materials are of interest for digital plate making systems. The heat mode type photosensitive material 50 is not limited to a photosensitive material using an evaporation film ablation method. Photosensitive materials utilizing thermal induced changes, such as phase transition and insolubilization, can also be used.

An exposure head 14 is arranged near the drum 12 and opposing the outer peripheral surface of the drum 12. The exposure head 14 is supported while being movable in the direction of a rotating axis of the drum 12. The opposite direction (arrow M direction) to the rotating direction (arrow X direction) of the drum 12 is the main scanning direction, and the direction of the rotating axis of the drum 12 (arrow S direction) is the sub-scanning direction, in which the exposure head 14 is moved. The two-dimensional image is formed (recorded) in the heat mode type photosensitive material 50 by sequentially scanning a laser beam output from the exposure head 14 in the main scanning direction and the sub-scanning direction.

An output portion 30B side of an optical fiber 30 is connected to the exposure head 14 through a holding member 18. An incident portion 30A side of the optical fiber 30 is connected to an optical unit 20 which includes a semiconductor laser 24 as the light source. A focusing lens 16 acting as an optical focusing system is arranged in the exposure head 14. The focusing lens 16 focuses the laser beam output from the optical fiber 30 onto an exposure surface (recording surface) of the heat mode type photosensitive material 50.

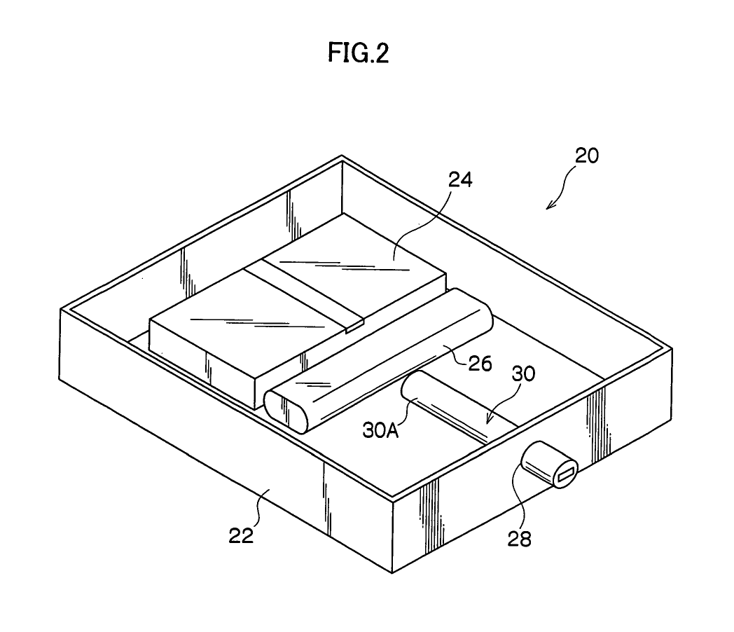

As shown in FIG. 2, the optical unit 20 includes the semiconductor laser 24 which emits the laser beam and a cylindrical lens 26 which focuses the laser beam output from the semiconductor laser 24 to the incident portion 30A of the optical fiber 30. The semiconductor laser 24 and the cylindrical lens 26 are fixed to an inside of a case 22. The incident portion 30A side of the optical fiber 30 is inserted into an opening 28 provided in a sidewall of the case 22 and fixed so that the incident portion 30A is brought close to a side face of the cylindrical lens 26. The high-output broad area type semiconductor laser with an output area of 50 μm by 1 μm, for example, can be used as the semiconductor laser 24.

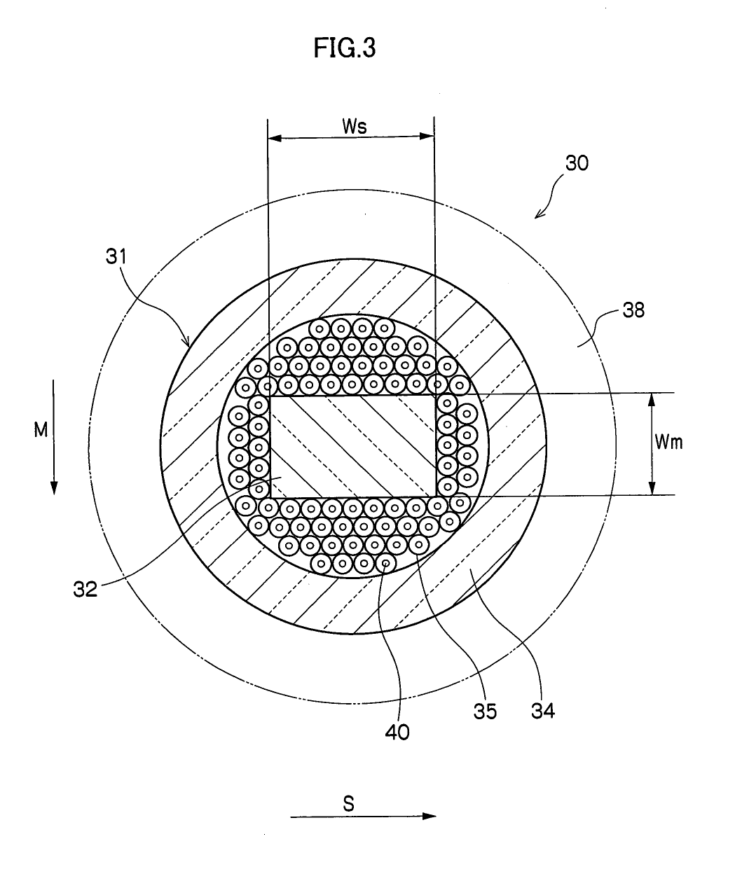

As shown in FIG. 3, in the optical fiber 30, the sectional shape of a core 32 in the direction orthogonal to the optical axis direction of the laser beam is rectangular. The optical fiber 30 is manufactured by the following method. A preform 31 is formed of the core 32, a cylindrical tube (second cladding) 36, and multiple hollow capillaries (first cladding) 34. In the core 32, a width Wm in the main scanning direction is smaller than a width Ws in the sub-scanning direction. The core 32 is covered with the tube 36, and is centered in the tube 36 with a predetermined spacing. The space between the core 32 and the tube 36 is filled with the hollow capillaries 34 so that substantially hexagonal close packed configurations are formed (at least in the portion near the core a hexagonal close packed configuration (with maximum density and) with no irregularities are formed). Wire drawing is performed at a predetermined tension on the preform 31 while it is heated to a predetermined temperature, and then a cover layer 38 is coated onto the outer peripheral surface of the tube 36.

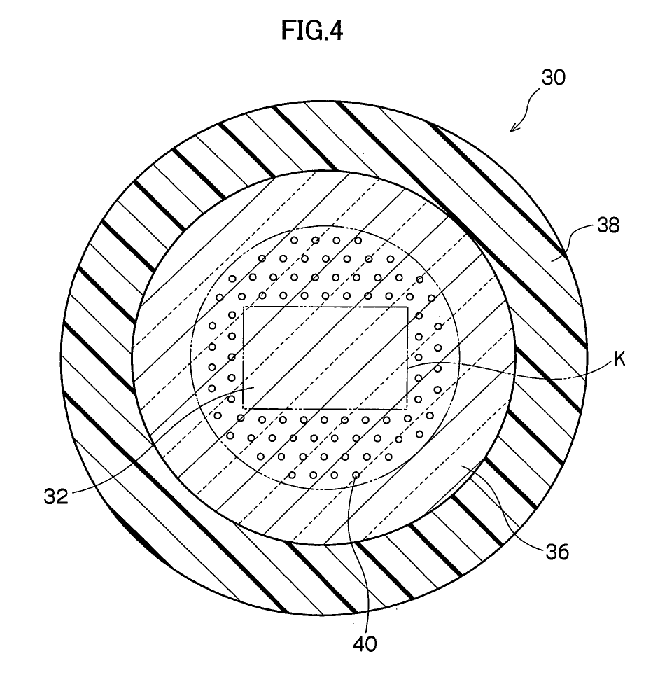

In the optical fiber 30, when the preform 31 is heated and wire-drawn, the hollow capillaries 34 are melt-fused, and the core 32, the hollow capillaries 34, and the tube 36 are integrated together as shown in FIG. 4. That is, the optical fiber 30 is formed so that the shape of the core of the preform 31 directly becomes the shape of the core of the optical fiber 30. Therefore, the optical fiber 30 has excellent reproducibility of size and shape of the rectangular core 32. Since the core 32 and the tube 36 are uniformly integrated by the hollow capillaries 34, the interfaces become ideal smooth surfaces. Accordingly, there is no possibility that scattering is generated. Further, a process of optically polishing the interfaces is not required, so that the optical fiber 30 can be reliably manufactured at low cost.

Between the core 32 and the tube 36, multiple holes 40 aligned in the optical axis direction of the laser beam are formed to have a periodic structure by the hollow capillaries 34. Particularly, the holes 40 near the core 32 are regularly arrayed by the forming of a hexagonal close packed configuration. Therefore, an effective refractive index is decreased by the multiple holes 40, so that the refractive index of the tube 36 becomes lower than that of the core 32, and the light (laser beam) can be guided while trapped in the core 32 (total reflection). Accordingly, the propagation loss of the light (quantity of the light loss) is decreased and a decrease in utilization efficiency of the laser beam is prevented.

For example, the core 32 and the hollow capillaries 34 can be made of anhydrous quartz, having a high refractive index, and the tube 36 can be made of quartz, glass or the like, having a refractive index lower than that of the anhydrous quartz. The cover layer 38 is made, for example, of ultraviolet curing resin having a refractive index lower than that of the tube 36. For example, in the optical fiber 30, the size (Wm by Ws) of the core 32 can be about 30 μm by 60 μm, an outer diameter of the first cladding which is formed by melt-fusing the hollow capillaries 34 can be about 90 μm, and the outer diameter of the second cladding (tube 36) can be about 125 μm. Although a small number of hollow capillaries 34 in contact with the inner surface of the tube 36 are drawn in FIG. 3, the hollow capillaries 34 are in fact packed without gaps in the actual optical fiber 30.

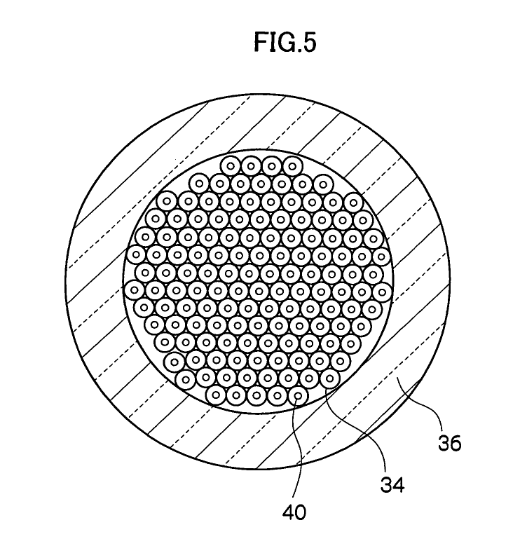

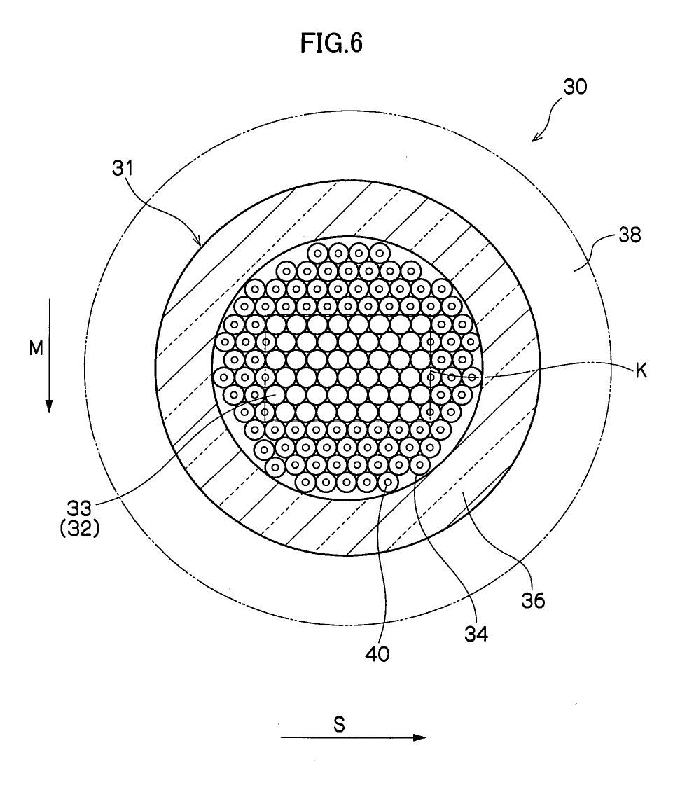

It is also possible to manufacture the optical fiber 30 in the following way. As shown in FIG. 5, first the inside of the tube 36 is filled with multiple hollow capillaries 34 so that a substantially close packed configuration is formed. Although similarly a small number of hollow capillaries 34 in contact with the inner surface of the tube 36 are drawn in FIG. 5, the hollow capillaries 34 are in fact packed without gaps in the actual optical fiber 30. Then, as shown in FIG. 6, the multiple hollow capillaries 34 located in a rectangular area (shown by a hypothetical line K in FIGS. 4 and 6) at substantially the center portion of the tube 36 are extracted, and quartz rods 33 which number as many as the number of extracted hollow capillaries 34 are inserted to replace of the hollow capillaries 34. The quartz rods 33 have the same diameter as the hollow capillaries 34.

After forming the preform 31, which includes the quartz rods 33, the hollow capillaries 34, and the tube 36, a similar wire drawing process is performed at a predetermined tension while the preform 31 is heated to a predetermined temperature. Then the cover layer 38 is coated onto the outer periphery. That is, the optical fiber 30 is manufactured by integrating the tube 36, the quartz rods 33 and the hollow capillaries 34 by heating and melt-fusing, and the cover layer 38 is coated onto the outer periphery surface of the tube 36.

Accordingly in this method of manufacturing the optical fiber 30, since the rectangular core 32 having a predetermined size is formed by melt-fusing multiple quartz rods 33, when compared with the optical fiber 30 shown in FIG. 3, it is not necessary to center the core 32 and the tube 36. This allows the optical fiber 30 shown in FIG. 6 to be easily manufactured. That is, the optical fiber 30 can be manufactured simply by substituting hollow capillaries 34 located at predetermined positions with quartz rods 33, so that the optical fiber 30 can more easily be manufactured.

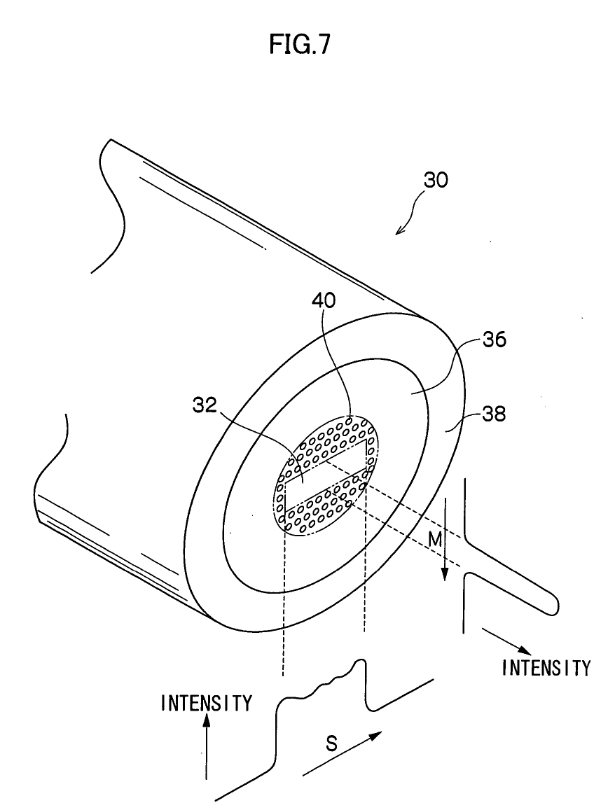

In the configurations in which the refractive indexes and the sectional shapes of the core 32 and the first cladding are formed in the above-described ways, when the intensity distribution is determined by integrating the light energy of the laser beam with respect to the main scanning direction orthogonal to the optical axis direction, the laser beam output from the optical fiber 30 exhibits a single mode intensity distribution (shape having a narrow single peak with respect to the main scanning direction) as shown in FIG. 7. Therefore, the beam spot size is easy to focus in the main scanning direction.

On the other hand, the light intensity distribution in the sub-scanning direction does not have a Gaussian distribution, and the light intensity distribution in the sub-scanning direction becomes substantially a broad rectangular shape. Therefore, even if the intensity of the laser beam is slightly changed, i.e., even if the light quantity is slightly changed, an extent of image formation (transverse width) determined by a threshold value for image formation of the heat mode type photosensitive material 50 is not changed, and the writing line width of the image with respect to the sub-scanning direction is held constant. When an area of gradation is constructed by using dots, the line width is held constant and so the dot density (coverage) is also held constant.

The operation of the optical fiber 30 and the image forming apparatus 10 having the above described configurations will be described below. In the optical unit 20, the laser beam output from the semiconductor laser 24, modulated according to image information, is condensed onto the incident portion 30A of the optical fiber 30, which acts as the optical transmission path, by the cylindrical lens 26, and the laser beam is transmitted through the optical fiber 30. Since the optical fiber 30 has the above-described configuration, the optical fiber 30 can sufficiently transmit a light quantity necessary for the formation (recording) of an image with little propagation loss.

In the exposure head 14, the laser beam transmitted through the optical fiber 30 is output from the output portion 30B of the optical fiber 30, held by the holding member 18. That is, the laser beam is output from the rectangular core 32, which is elongated in the sub-scanning direction. The laser beam output from the core 32 is focused with the focusing lens 16, the exposure surface of the heat mode type photosensitive material 50 is irradiated with the laser beam having a beam spot in which the beam size (width) in the main scanning direction is narrower than that in the sub-scanning direction (the beam spot being elongated, and stretched out, in the sub-scanning direction), and an image based on the image information is formed (recorded) on the exposure surface.

The laser beam output from the core 32 of the optical fiber 30 has a profile in which the rectangular spot is elongated extending out in the sub-scanning direction, so that the spot size in the main scanning direction is easily focused. The light intensity of the laser beam is substantially constant in the transverse width direction. Even if the light quantity, the sensitivity of the heat mode type photosensitive material 50 or the like is varied, neither the line width nor the dot density varies substantially. Therefore, a good image can reliably be formed (recorded) on the exposure surface of the heat mode type photosensitive material 50.

The heat mode type photosensitive material 50 is one in which recording is performed by causing a physical or chemical change by photo-thermal conversion after exposure. When exposure speed becomes slow, the heat mode type photosensitive material 50 has low-intensity reciprocity law failure characteristics in which a greater exposure energy is required due to the heat generated being dissipated. When the image is formed (recorded) on the heat mode type photosensitive material 50 by using the optical fiber 30, having the core 32 whose sectional shape is rectangular elongated in the sub-scanning direction, the main scanning speed during the process (rotating speed of the drum 12) becomes substantially constant, so that short-time, high-intensity exposure can be realized saving exposure energy. That is, for a given exposure energy, the exposure speed can be increased (high-speed exposure can be performed).

In this case, a high-output broad area type semiconductor laser 24 is used as the light source. However, the light source of the invention is not limited to this, and it is also possible to use a general semiconductor laser having a circular spot shape. However, when a broad area type semiconductor laser 24 is used, the profile of the output light beam becomes rectangular, so that incident efficiency onto the optical fiber 30 having the rectangular core 32 is improved. It is also possible that exposure is performed with multiple laser beams by arranging multiple semiconductor lasers 24 (optical units 20). In this case, the processing speed of the image forming apparatus 10 can be increased.

It is possible that the optical fiber 30 is formed in such a way that the length of the optical fiber can be lengthened or adjusted. If this is done, because the semiconductor laser 24 (optical unit 20) and the exposure head 14 can be arranged so as to be separated from each other, the degree of freedom of layout is enhanced such that configurations in which the cooling efficiency is improved, in both the semiconductor laser 24 and the exposure head 14, can be easily realized. In the drawings, one optical fiber 30 is used. However, it is also possible that two or more optical fibers 30 are used by connecting optical fibers 30 with optical joints such as fitting connectors. When an optical joint is used, it is easy to separate the optical unit 20 (semiconductor laser 24) from the exposure head 14, so that semiconductor lasers 24 can be easily replaced if they malfunction.

Although a heat mode type photosensitive material 50 using the evaporation film ablation method is used as the recording medium in the embodiment, the recording medium has no particular limitation as long as scanning exposure can be performed with a laser beam onto the recording medium. Diazo photosensitive materials, silver halide photosensitive materials, photopolymerization photosensitive materials, and the like can be used in the invention. Further, photosensitive materials which exhibit low-intensity reciprocity law failure characteristics in a time period corresponding to a pixel exposure time can also be used with no particular limitation.

In the image forming apparatus of the invention, it is preferable that the width of the core of the optical fiber in the main scanning direction is shorter than that in the sub-scanning direction.

In the optical fiber, since the width of the core of the optical fiber in the main scanning direction is shorter than that in the sub-scanning direction, the beam size in the main scanning direction is reduced to smaller than that in the sub-scanning direction. Therefore, high-intensity short-time exposure can be performed, and the exposure can be performed particularly effectively when the recording medium is a heat mode type photosensitive material.

That is, when the exposure speed becomes slow, a heat mode type photosensitive material has low-intensity reciprocity law failure characteristics in which heat generated is dissipated, requiring a larger amount of exposure energy (characteristics such that the sensitivity of a photosensitive material decreases as the intensity decreases and the exposure time becomes longer). Therefore, when the beam size in the main scanning direction is formed smaller than that in the sub-scanning direction, the scanning time can be shortened (instantaneous exposure can be performed) and the exposure energy can be decreased. This means that a good image can be obtained with a heat mode type photosensitive material.

In the image forming apparatus, it is preferable that the light source is a broad area type semiconductor laser.

A high-output light beam can be obtained by forming the light source with such a broad area type semiconductor laser. Since the profile of the output light becomes rectangular, the incident efficiency onto an optical fiber having a rectangular core is improved.

1. An optical fiber comprising:
a core whose sectional shape in a direction orthogonal to an optical axis direction of a light beam is a rectangle; and
a cladding with which the core is covered,
wherein the cladding comprises a structure formed of a plurality of hollow capillaries integrated with the core by melt-fusing.

2. An optical fiber according to claim 1, wherein a plurality of holes which are aligned in the optical axis direction of the light beam are formed to have a substantially periodic structure within the cladding by melt-fusing the plurality of hollow capillaries in the cladding.

3. An optical fiber according to claim 1, wherein the cladding comprises a cylindrical tube which surrounds the core, and is separated from the core by a predetermined spacing.

4. An optical fiber according to claim 3, wherein the cladding comprises a structure formed by arranging the plurality of hollow capillaries between the coaxially positioned core and the cylindrical tube covering, and arranging the hollow capillaries so as to form a substantially hexagonal close packed configuration.

5. An optical fiber according to claim 4, wherein the cladding comprises a structure formed by arranging at least the hollow capillaries close to the core so as to form a hexagonal close packed configuration.

6. An optical fiber according to claim 1, wherein an interface between the core and the cladding becomes a smooth surface by melt-fusing the plurality of hollow capillaries.

7. A method of manufacturing an optical fiber comprising:
forming a base material of a core whose section is rectangular;
inserting the base material of the core into a cylindrical tube and arranging coaxially the base material of the core and the tube;
producing a preform by filling the tube into which the base material of the core has been inserted with a plurality of hollow capillaries;
performing wire drawing while the preform is melt-fused; and
covering the preform with a cover layer to produce an optical fiber having the rectangular core.

8. A method of manufacturing an optical fiber according to claim 7, wherein the base material of the core and the plurality of hollow capillaries are made of anhydrous quartz having high refractive indexes,
the tube is made of any one of quartz and glass having a refractive index lower than the refractive indexes of the base material of the core and the plurality of hollow capillaries, and
the cover layer is made of ultraviolet curing resin having a refractive index lower than that of the tube.

9. A method of manufacturing an optical fiber according to claim 7, wherein the producing the preform includes filling the tube with the plurality of hollow capillaries so that a substantially hexagonal close packed configuration is formed.

10. A method of manufacturing an optical fiber according to claim 9, wherein at least the hollow capillaries close to the core are arranged so as to form a hexagonal close packed configuration.

11. A method of manufacturing an optical fiber comprising:
filling a cylindrical tube with a plurality of hollow capillaries;
extracting hollow capillaries, from the plurality of hollow capillaries with which the tube is filled, in a rectangular area having a predetermined size in a portion substantially central to the cylindrical tube, and inserting rods having the same diameter as the extracted hollow capillaries replaced to produce a preform;
performing wire drawing while the preform is melt-fused; and
covering the preform with a cover layer to produce an optical fiber having the rectangular core.

12. A method of manufacturing an optical fiber according to claim 11, wherein the filling of the tube with the plurality of hollow capillaries forms a substantially hexagonal close packed configuration.

13. A method of manufacturing an optical fiber according to claim 11, wherein the number of the rods inserted is equal to the number of extracted hollow capillaries.

14. A method of manufacturing an optical fiber according to claim 11, wherein the rods are made of quartz.

15. A method of manufacturing an optical fiber according to claim 11, wherein the rods and the plurality of hollow capillaries are made of anhydrous quartz having high refractive indexes,
the tube is made of any one of quartz and glass having a refractive index lower than the refractive indexes of the rods and the plurality of hollow capillaries, and
the cover layer is made of ultraviolet curing resin having a refractive index lower than that of the tube.

16. An image forming apparatus comprising:
a light source which emits a light beam;
an optical fiber which is optically connected to the light source, the optical fiber being formed with
a core, whose sectional shape in a direction orthogonal to an optical axis direction of a light beam is a rectangle, and
a cladding, with which the core is covered, the cladding including a plurality of hollow capillaries integrated with the core by melt-fusing; and
an optical focusing system which focuses the light beam output from the optical fiber onto a recording medium.

17. An image forming apparatus according to claim 16, wherein a width of the core of the optical fiber in a main scanning direction is smaller than a width in a sub-scanning direction.

18. An image forming apparatus according to claim 16, wherein the light source comprises a broad area type semiconductor laser.

19. An image forming apparatus according to claim 16, wherein the light source includes a plurality of semiconductor lasers.

20. An image forming apparatus according to claim 16, wherein the recording medium is made of heat mode type photosensitive material.
